(19) United States
(12) Patent Application Publication
(10) Pub. No.: US 2010/0181421 A1
(43) Pub. Date: Jul. 22, 2010

(54) TWO-STAGE AIRBAG INFLATION SYSTEM WITH PYROTECHNIC DELAY

(76) Inventors: David Albagli, Haifa (IL); Nathan Libis, Haifa (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/666,757

(22) PCT Filed: Jun. 23, 2008
(86) PCT No.: PCT/IL08/00854

§ 371 Date: Dec. 24, 2009

(30) Foreign Application Priority Data
Jun. 25, 2007 (IL) 184216

(51) Int. Cl. B64D 45/04; B60R 21/26; F42B 3/04; B64C 25/00

(52) U.S. Cl. 244/100 A; 102/530

(57) ABSTRACT

A two-stage pyrotechnic gas generator for inflating an airbag has a housing with first and second chambers each having gas release apertures. The chambers are separated by a partition having an opening. Running through the gas generator is an essentially contiguous train of combustible material including a train of fast burning material passing through the first chamber to the opening, a pyrotechnic delay element associated with the opening, and a train of fast burning material within the second chamber. The first and second chambers each include a quantity of propellant deployed to be ignited by the corresponding train of fast burning material. An initiator, associated with the first chamber, is configured to initiate combustion of the essentially contiguous train of combustible material. As a result, the second quantity of propellant is ignited at a predefined delay relative to ignition of the first quantity of propellant to achieve precisely timed two-phase inflation with a single electronic initiator.

### FIELD AND BACKGROUND OF THE INVENTION

The present invention relates to airbag inflation systems and, in particular, it concerns an airbag inflation system having two or more stages which are ignited sequentially by use of a pyrotechnic delay.

U.S. Pat. No. 5,992,794 to Rotman at al. teaches a crash protection system for helicopters based on inflatable airbags. The airbags are inflated either automatically or manually, or a combination of both, prior to the helicopter striking the ground, thus ameliorating the results of a crash. Proximity sensors detect a fast descent to trigger inflation of the airbags located beneath the helicopter fuselage so that they cushion the impact with the ground. In most cases, effective protection for a helicopter requires multiple airbags, each of considerable size and volume (order of magnitude of several hundreds of liters). According to the Rotman patent, the activation of the inflation system is preferably triggered by a proximity sensor, in close proximity to the ground. However, this approach presents various design problems. Firstly, inflation of an airbag of several hundreds of liters requires a very significant mass flux of inflating gases (compared to that of an automotive airbag which is typically 60 liters and inflates in 60-80 milliseconds). This very fast process generally results in high pressure requirements that are difficult for the airbag to withstand. A further problem is that the proximity sensors may be quite inaccurate and depend on the type of terrain (soil, vegetation, mud, ice, snow, rocks). The inaccuracy of the sensors could be well in the range of 2-3 meters. Therefore it is advisable to trigger the inflation at a higher altitude to ensure complete inflation in all cases despite the margin of sensor error. The order of magnitude of the allowable inflation time may therefore be 700 to 900 milliseconds.

Taking in account the above points, a two-stage inflation system is preferable, with a first stage of airbag deployment and initial inflation and a second stage of completing the inflation. This approach leads to a more gradual and less violent inflation system. The second stage also serves to maintain the desired degree of inflation of the airbag despite pressure losses due to cooling of the gases in the airbag during the relatively long operation time and due to any leakage through the inherently porous walls of the airbag.

In the context of automotive airbags, it has been taught to use a two-stage inflation system to reduce the risk of passenger injury during inflation of the airbag. An example of such a system has been taught for inflating automotive airbags by Daoud in U.S. Pat. No. 6,877,435. In the Daoud invention, there are two chambers, each with a propellant charge and an electrical initiator.

The ignition of the airbag system for helicopter-protection presents new problems, which are not characteristic of the requirements of airbags for automotive passenger protection. Specifically, numerous airbags are required to protect a helicopter. If two-stage inflation systems such as that of Daoud were used, the number of electrical initiators required would be twice the number of inflation systems. This would result in an excessive requirement of electric wiring from the central ignition system, triggered by the ground proximity sensor or any other triggering arrangement, to the individual electrical initiators to ignite the each propellant in each individual chamber. Furthermore, each ignition line has to be protected by external disturbances such as Electro-Magnetic Interference, which might cause inadvertent activation of the initiators. The multitude of initiators and the associated wiring and circuitry involved would create a significant reliability problem.

An additional issue is the fact that it is desirable to protect each electrical initiator by a Safety and Arming (S&A) Device, which would protect the initiator from inadvertent ignition due to external disturbances and thereby protect the maintenance personnel of the helicopter during ground maintenance. Doubling of the number of S&A devices would add an additional layer of complexity, additional cost and additional reliability issues.

An alternative approach to reducing risk of injury to passengers of a motor vehicle is presented in U.S. Pat. No. 6,289,820 to Anacker et al. In this document, a hybrid inflation system is presented which employs a combination of a pyrotechnic gas generator and a pre-pressurized gas storage chamber. The pyrotechnic gas generator typically has two solid charges which are ignited in succession, either by separate initiators or by a pyrotechnic delay which is triggered by hot gases within a first chamber. The former option has the aforementioned problems of multiplying the number of initiators, which would be a problem for a system such as a helicopter airbag system with multiple airbags. The latter option is also problematic due to the lack of precision in synchronizing ignition where the pyrotechnic delay is ignited by hot gases in the chamber which may take more or less time to achieve ignition.

There is therefore a need for a two-stage pyrotechnic gas generator which would achieve precise synchronization between ignition of two gas generating charges while only requiring a single electrical initiator to trigger the gas generator.

### SUMMARY OF THE INVENTION

The present invention is provides a two-stage inflation system with an electrical initiator that ignites the first stage, the combustion of the first stage activating the input of a pyrotechnic delay, and the output thereof igniting the second stage. The overall reliability of the proposed single initiator inflation system is much higher than the reliability of multi-initiator, multi-circuit ignition systems of the prior art, and the precision of synchronization between the two stages is much better than hot-gas-ignited initiation of the second chamber.

The electrical initiator is preferably protected by an S&A device. The S&A provides a barrier between the igniting charge provided in the electrical initiator and the first combustion chamber. This barrier is preferably reversibly removed according to system-level command signals by using an electromechanical actuator, such as a solenoid. Other types of sensing elements could be also used in the S&A device that would enable arming upon certain flight conditions (such as vibrations peculiar to the helicopter dynamics) or upon detection of abnormal dynamic conditions leading to crash.

According to the teachings of the present invention there is provided, a two-stage pyrotechnic gas generator for inflating an airbag, the gas generator comprising: (a) a housing defining at least a first chamber having at least one gas release aperture and a second chamber having at least one gas release aperture, the housing further defining a partition separating between the first and second chambers, the partition including an opening; (b) an essentially contiguous train of combustible material including: (i) a train of fast burning material passing through the first chamber to the opening, (ii) a pyrotechnic delay element associated with the opening, and (iii) a train of fast burning material within the second chamber; (c) a first quantity of propellant associated with the train of fast burning material in the first chamber; (d) a second quantity of propellant associated with the train of fast burning material in the second chamber; and (e) an initiator associated with the first chamber and configured to initiate combustion of the essentially contiguous train of combustible material, such that the second quantity of propellant is ignited at a predefined delay relative to ignition of the first quantity of propellant.

According to a further feature of the present invention, the essentially contiguous train of combustible material is arranged as a core, and wherein the first and second quantities of propellant are implemented as annular disks deployed around the core.

According to a further feature of the present invention, there is also provided a safe-and-arm device associated with the initiator and configured to selectively inhibit initiation of combustion of the essentially contiguous train of combustible material.

According to a further feature of the present invention: (a) the housing further defines a third chamber having at least one gas release aperture and a second partition separating between the second and third chambers, the second partition including an opening; and (b) the essentially contiguous train of combustible material further includes: (i) a second pyrotechnic delay element associated with the opening in the second partition, and (ii) a train of fast burning material within the third chamber; (c) the gas generator further comprising a third quantity of propellant associated with the train of fast burning material in the third chamber.

There is also provided according to the teachings of the present invention, a helicopter crash protection system comprising a plurality of inflatable airbags associated with an underside of the helicopter, each of the airbags provided with a gas generator of the aforementioned type.

According to a further feature of the present invention, there is also provided a crash sensor arrangement configured for sensing an imminent crash condition for the helicopter, the gas generators being actuated responsively to the crash sensor arrangement.

### BRIEF DESCRIPTION OF THE DRAWINGS

The invention is herein described, by way of example only, with reference to the accompanying drawings, wherein:

FIG. 1 is a schematic side view of a helicopter equipped with inflatable airbags;

FIG. 2 is a block-diagram of an inflation system, constructed and operative according to the teachings of the present invention; and

FIG. 3 is a schematic cross-sectional view taken through a two-stage gas generator, constructed and operative according to the teachings of the present invention, including a pyrotechnic delay element, the gas generator being configured for use in the inflation system of FIG. 2.

### DESCRIPTION OF THE PREFERRED EMBODIMENTS

The present invention is a two-stage gas generator for inflating airbags, and a corresponding helicopter crash protection system employing airbags inflated by such gas generators.

The principles and operation of gas generators and helicopter crash protection systems according to the present invention may be better understood with reference to the drawings and the accompanying description.

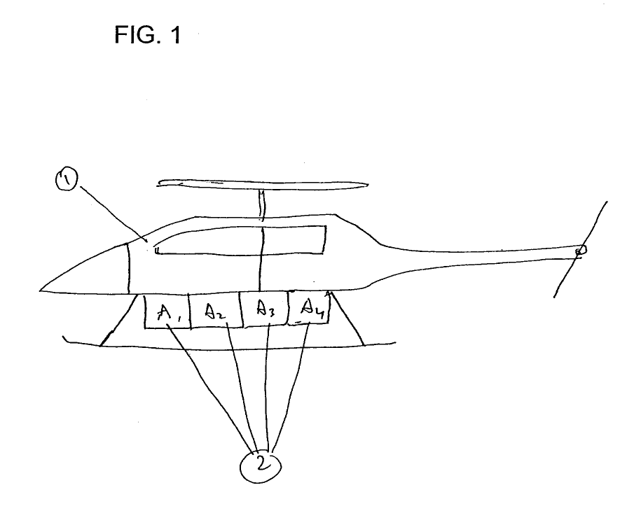

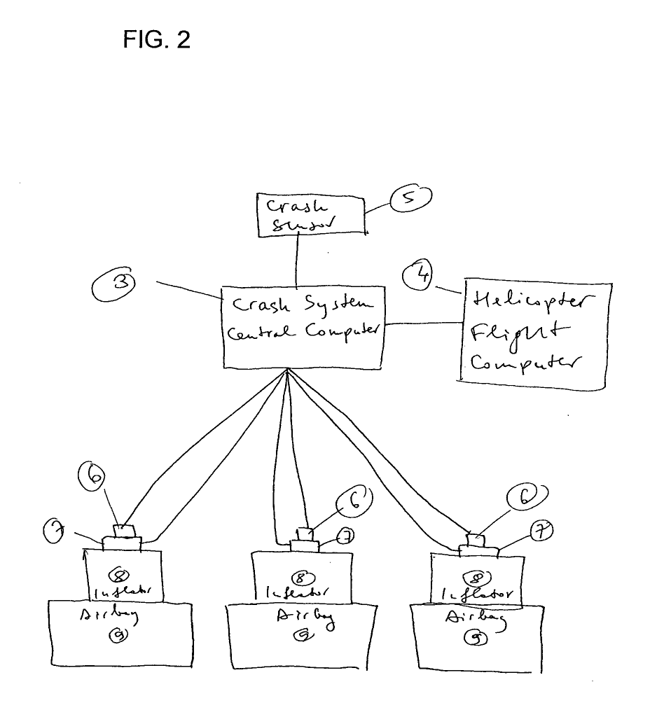

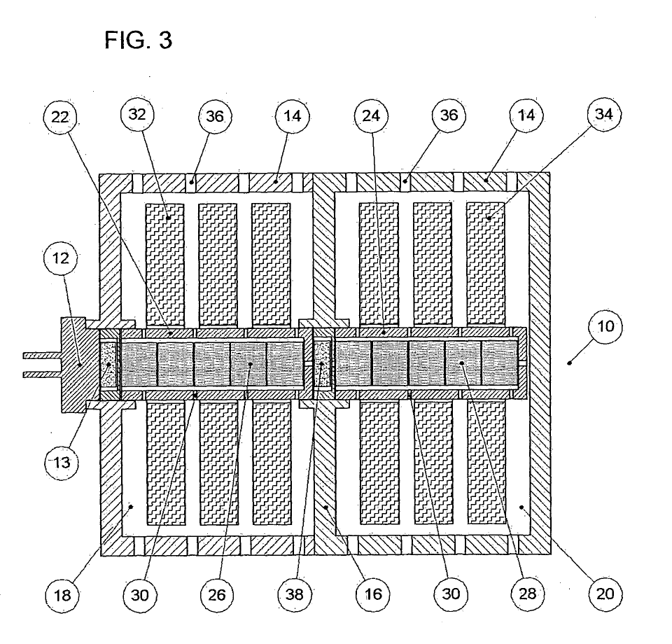

Referring now to the drawings, FIGS. 1 and 2 illustrate schematically a helicopter crash protection system while FIG. 3 shows details of the preferred gas generator implementation for use in the crash protection system.

Referring to FIG. 3, in general terms, the present invention provides a two-stage pyrotechnic gas generator 10 for inflating an airbag which has a housing 14 with first and second chambers 18, 20 each having gas release apertures 36. The chambers are separated by a partition 16 having an opening. Running through the gas generator is an essentially contiguous train of combustible material including a train of fast burning material 26 passing through the first chamber to the opening, a pyrotechnic delay element 38 associated with the opening, and a train of fast burning material 28 within the second chamber. The first and second chambers each include a quantity of propellant 32, 34 deployed to be ignited by the corresponding train of fast burning material 26, 28. An initiator 12, associated with the first chamber, is configured to initiate combustion of the essentially contiguous train of combustible material. As a result, the second quantity of propellant is ignited at a predefined delay relative to ignition of the first quantity of propellant to achieve precisely timed two-phase inflation with a single electronic initiator.

The train of combustible material is described as “essentially contiguous” in the sense that it propagates combustion along the train without relying upon hot gases released into the volume of a chamber to ignite the next element. As will be clear to one ordinarily skilled in the art, the phrase “essentially contiguous” thus defined allows for small spaces within or between elements in the train. Typically, such spaces are no greater than about one millimeter. The use of an essentially contiguous train of combustible material ensures a degree of precision in the relative timing of the phases of inflation which could not be reliably achieved through ignition of subsequent elements by hot gases already released into a chamber.

Thus, the present invention provides a new type of gas generator that is particularly useful in helicopter protection systems. These gas generators have at least two chambers, which condition allows the respective gas volumes to be produced under different conditions, i.e., the profile of pressure vs. time for the gas volume produced by each chamber can be different. In this way, by designing multiple chambers differently, the gas generator can be adapted to the need of the particular application.

The airbag is designed to activate upon detection of imminent crash. The crash sensor provides the necessary signal for the system electronics to provide the inflation command to the appropriate electrical initiator. The commands to the various airbags may be provided simultaneously or at staggered points in time.

A variety of design considerations must be taken into account in developing an airbag impact protection system. First, the inflator must be capable of producing and/or releasing a sufficient quantity of gas to the airbag within the time limitation required. Given the time limitation involved in airbag restraint systems, the airbag must deploy in several hundreds of milliseconds, depending upon the size and location of the airbag. Inflators must generally be capable of filling an airbag in these time frames with several hundreds of liters.

In operation, the gas generator receives a signal from an exterior source, which would typically be a logical circuit in the helicopter electronic system, connected to the crash-detection sensor. As the initiator functions, the gas generant (propellant) in the first chamber is ignited. A pyrotechnic delay is provided between the first and second chamber, and between further subsequent phases, if applicable. The combustion of the first stage provides the input for activation of the pyrotechnic element between the first stage and second stage. Before being consumed by combustion, the pyrotechnic delay elements constitute the barrier that prevents propagation of the combustion between two adjacent combustion chambers. Once such barrier is consumed as the delay elapses, the chain of combustion proceeds to the propellant in the second chamber.

The combustion of the second stage results in further inflation of the airbag. Further stages may be added and ignited according to the same principle. Depending on the desired application, the second gas generant in the second chamber (as well as any subsequent gas generants in additional chambers) can be tailored to be less progressive, neutral, or regressive as compared to the first gas generant. Subsequent stages may be provided with differing propellant compositions.

Upon receipt of the signal to the initiator(s), the more progressive gas generant undergoes rapid ignition and preferably generates sufficient pressure to inflate the airbag to 10%-90% of its full capacity, more preferably 30% to 70% of its capacity, and most preferably 55%-65% of its full capacity. The second gas generant (in the second chamber), is initiated at some given time t=10%-90% of tₚₘₐₓ (first gas generator), (i.e., when 10-90% of the gas has been generated from the first generator), preferably 30%-70% of tₚₘₐₓ (first gas generator), but most preferably at t=55%-65% of tₚₘₐₓ (first gas generator).

FIG. 1 shows a helicopter 1 with several airbags 2 stowed under its body. As taught in U.S. Pat. No. 5,992,794 to Rotman at al., these airbags are inflated upon crash and thereby provide a certain amount of crash-protection to the helicopter crew.

FIG. 2 displays a top-level block-diagram of the inflation system. The Crash System Central Computer 3 is physically and functionally connected to the Helicopter Flight Computer 4 as well as to the Crash Sensor 5 installed on the helicopter. Based on the flight data, the Central Computer estimates the fight conditions in which there might be a crash hazard and delivers a reversible arm command to the igniter S&A devices 7. In this position, the pyrotechnic train between the airbag igniters 6 onto the inflators 8 becomes uninterrupted and upon crash detection and subsequent receipt of the ignition stimulus the inflators 8 function. As previously mentioned, the S&A devices 7 are desirable but not required. Upon functioning of the inflators 8, the airbags 9 become inflated.

FIG. 3 illustrates the structure of a multi-chamber inflator (in this case a dual-stage inflator 10) activated by one electro-pyrotechnical initiator 12. As known to those familiar with the art of pyrotechnic devices, the electro-pyrotechnical initiator 12 contains a bridgewire that is heated by electrical current and thereby ignites a small pyrotechnic charge 13 (typically Zirconium/Potassium Perchlorate) included in the same unit. This pyrotechnic unit serves as the first stage of the pyrotechnic train. Initiator 12 is mounted (for example by thread) to inflator casing 14, made typically of stainless steel. Inflator casing 14 is divided by a partition wall 16 into two chambers 18 and 20.

The first stage igniter body 22 and the second stage igniter body 24 (both typically of stainless steel), screw onto the chamber wall and the partition wall respectively. Both igniter bodies are filled with BPN (Boron+Potassium Nitrate) igniter pellets 26 and 28 in the first stage igniter and second stage igniter respectively, and are provided with orifices 30 for the egress of the combustion products. The disc-shaped propellant slices 32 and 34 in the first stage and second stage respectively are mounted onto igniter bodies. A typical composition of these propellant charges includes 50-70% Ammonium Perchlorate, 15-30% Ammonium Sulfate and 15-25% HTPB (Hydroxyl-Terminated Polybutadiene). The first-stage and second-stage propellants may not be of the same composition, for example, if the performance requirements dictate differing pressure curves for the subsequent phases.

Once the initiator charge 13 is ignited, the combustion propagates to the BPN pellets 26 inside the first-stage igniter body. These pellets burn and the gases resulting from their combustion egress through orifices 30 to ignite propellant 32. The propellant burns and its gases egress through holes 36 in the chamber wall to provide gases for the airbag inflation. Within the partition wall 16 there is installed a delay charge 38. This charge is ignited as combustion proceeds through the igniter body and, once it is consumed, combustion propagates to pellets 28 inside the second-stage igniter body. These pellets burn and the gases resulting from their combustion egress through orifices 30 to ignite propellant 34. The propellant burns and its gases egress through holes 36 in the chamber wall to provide gases for the airbag inflation. The material used in pyrotechnic delay may be any suitable combustible material know in the art for this purpose. In certain cases, the igniter body and the delay element may be implemented using the same compositions, differing only in the level of compaction and consequent combustion rates, all as is known in the art.

It should be noted that, depending on the inflation requirements and on the configuration of the airbag itself, there might be a cooling phase between inflator 10 and the airbags themselves; the cooling may be implemented according to processes well-known to those familiar with the area of airbag inflators (including hybrid inflators) and do not per se constitute a part of the present invention.

It will be appreciated that the above descriptions are intended only to serve as examples, and that many other embodiments are possible within the scope of the present invention as defined in the appended claims.

What is claimed is:

1. A two-stage pyrotechnic gas generator for inflating an airbag, the gas generator comprising:
(a) a housing defining at least a first chamber having at least one gas release aperture and a second chamber having at least one gas release aperture, said housing further defining a partition separating between said first and second chambers, said partition including an opening;
(b) an essentially contiguous train of combustible material including:
(i) a train of fast burning material passing through said first chamber to said opening,
(ii) a pyrotechnic delay element associated with said opening, and
(iii) a train of fast burning material within said second chamber;
(c) a first quantity of propellant associated with said train of fast burning material in said first chamber;
(d) a second quantity of propellant associated with said train of fast burning material in said second chamber; and
(e) an initiator associated with said first chamber and configured to initiate combustion of said essentially contiguous train of combustible material,
such that said second quantity of propellant is ignited at a predefined delay relative to ignition of said first quantity of propellant.

2. The gas generator of claim 1, wherein said essentially contiguous train of combustible material is arranged as a core, and wherein said first and second quantities of propellant are implemented as annular disks deployed around said core.

3. The gas generator of claim 1, further comprising a safe-and-arm device associated with said initiator and configured to selectively inhibit initiation of combustion of said essentially contiguous train of combustible material.

4. The gas generator of claim 1, wherein:
(a) said housing further defines a third chamber having at least one gas release aperture and a second partition separating between said second and third chambers, said second partition including an opening; and
(b) said essentially contiguous train of combustible material further includes:
(i) a second pyrotechnic delay element associated with said opening in said second partition, and
(ii) a train of fast burning material within said third chamber;
the gas generator further comprising a third quantity of propellant associated with said train of fast burning material in said third chamber.

5. A helicopter crash protection system comprising a plurality of inflatable airbags associated with an underside of the helicopter, each of said airbags provided with a gas generator according to claim 1.

6. The helicopter crash protection system of claim 5, further comprising a crash sensor arrangement configured for sensing an imminent crash condition for the helicopter, the gas generators being actuated responsively to said crash sensor arrangement.
